(19) United States
(12) Patent Application Publication
(10) Pub. No.: US 2010/0203975 A1
(43) Pub. Date: Aug. 12, 2010

(54) Flexible Rotary Tool Attachment

(76) Inventor: David George Yaksic, Orland Park, IL (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/687,569

(22) Filed: Jan. 14, 2010

Related U.S. Application Data
(60) Provisional application No. 61/144,937, filed on Jan. 15, 2009.

(51) Int. Cl. F16C 1/06

(52) U.S. Cl. 464/52

(57) ABSTRACT

An apparatus for facilitating use of a rotary tool such as a grinder or the like in working on surfaces around bends or within a cavity utilizes a protective sheath of selectable length that is releasably held to the body of the rotary tool and provides a passage way for the flexible drive extender. The protective sheath can be configured by the user to meet his needs.

The present application claims priority from provisional patent application No. 61/144937 filed Jan. 15, 2009.

The present invention relates to the field of rotary tools such as grinders or drills. More specifically, the present invention is an adaptor and flexible drive extender to facilitate utilization of a rotary tool around bends or inside cavities.

### SUMMARY OF THE INVENTION

It is an object of the present apparatus to utilize only one hand while directing the work implement of a rotary tool in hard to reach places such as around bends and inside cavities.

It is a further object of the apparatus to improve the safety of a rotary tool incorporating a flexible drive extender.

The present embodiment of the apparatus accomplishes these and other objects of the designer by providing a protective sheath that is held to the body of the rotary tool and provides a passage way for the flexible drive extender which can be configured by the user to meet his needs.

These and other objects and advantages of the invention will become apparent from the following detailed description of the apparatus.

### BRIEF DESCRIPTION OF THE DRAWINGS

An embodiment of the flexible rotary tool attachment is depicted in the accompanying drawings which form a portion of this disclosure and wherein:

FIG. 1 is an exploded side elevation view of a first embodiment of the apparatus;

FIG. 2 is a pictorial side elevation view of the apparatus attached to a rotary tool;

FIG. 3 is a pictorial side elevation view of the apparatus partially detached from the rotary drive unit with the flexible drive extender attached to the rotary drive unit; and,

FIG. 4 is an exploded side elevation view of a second embodiment of the apparatus.

FIG. 5 is an exploded side elevation view of a third embodiment of the apparatus.

FIG. 6 is a side elevational view of the housing adapter of the present invention;

FIGS. 7a and 7b are side elevational view of terminal tool mandrels,

FIGS. 8a and 8b are pictorial views showing a portion of the apparatus in various stages of assembly with an adapter with internal female threads;

FIGS. 9a and 9b are pictorial views showing apparatus in various stages of assembly at the terminal end;

FIG. 10 is a pictorial view of an adapter with external male threads;

FIG. 11 is a pictorial perspective view of an adapter with a compression fitting holding the housing to rotary tool;

FIGS. 12a and 12b are pictorial views of a sample terminal tool

FIG. 13 is a pictorial of sample flex configurations with an array of terminal tools.

### DETAILED DESCRIPTION OF INVENTION

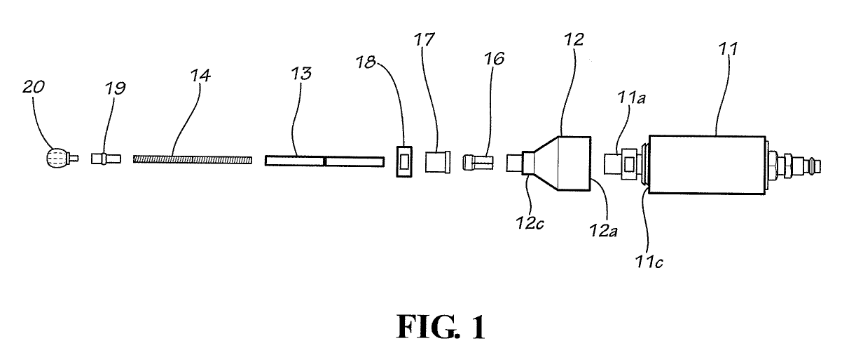

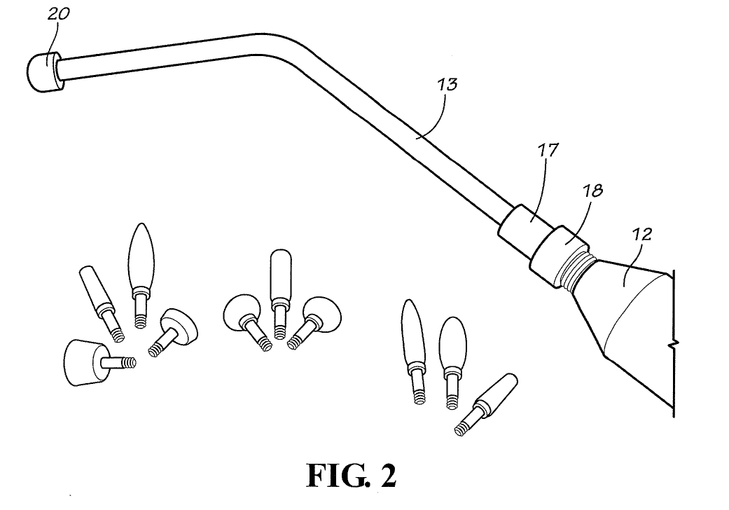

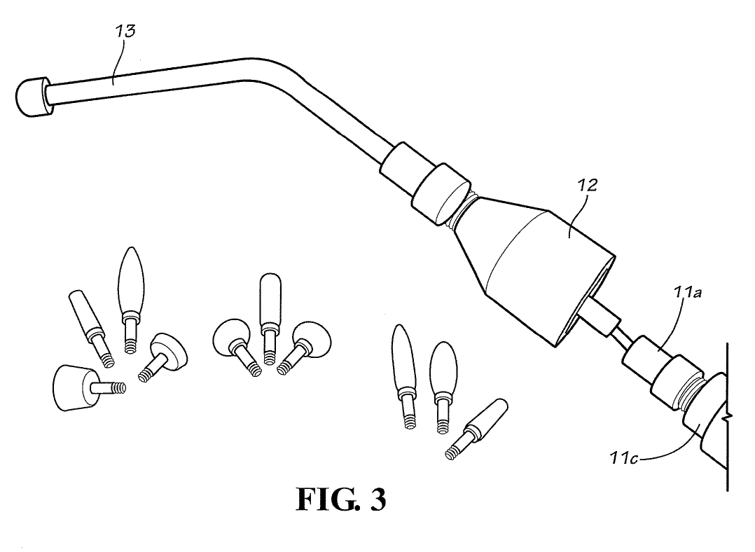

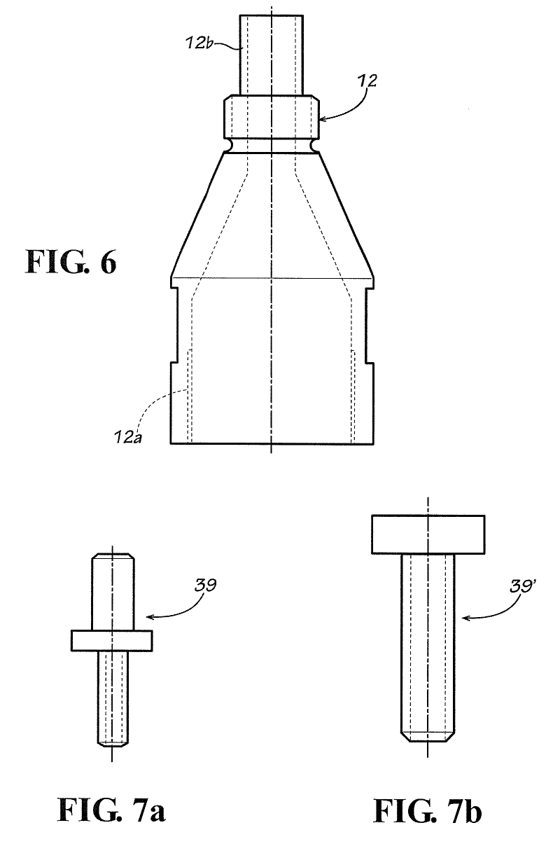

Referring to the FIGS. 1-13 for a clearer understanding of the invention, it may be seen that the present embodiment of the invention contemplates attachment to a grinder 11 or other rotary drive unit, which may be a fluid powered drive, an air powered drive, or an electrical drive. Regardless of the motive power of the grinder, it is contemplated that the grinder 11 will have a rotary output including an output chuck 11a and a threaded connector 11c having a male thread formed thereon for attachment of various shields and peripheral items. Threaded connector 11c is affixed or integral to the grinder 11 or a housing on the grinder 11 and is coaxial with chuck 11a. Other connections, such as a bayonet connection or a snap-lock connection may be used when appropriate for the interface between the grinder 11 and the adapter 12 described hereinafter.

A housing adapter 12 in the form of a hollow truncated cone is provided with internal female thread 12a, matingly compatible with threaded connector 11e, formed at a tubular first end such that housing adapter 12 may be securely attached to grinder 11. Other connections may be used as noted above. An opposite tubular end of housing adaptor 12 has a male thread 12b formed thereon. Between the first and opposite ends of housing adapter 12 the truncated cone is reduced in diameter from a size sufficient to engage female thread 12a on connector 11c to a smaller size sufficiently large enough to surround a protective sheath 13 which in turn has an internal diameter sufficient to allow free rotation of flexible drive extender 14 which may be a cable such as used in speedometer applications.

Protective sheath 13 is preferably made of metal tubing that will not crush or wear prematurely due to internal contact with rotating flexible drive extender 14, yet will be flexible enough to allow a user to bend it, such as with an elbow bend to facilitate working around corners or inside cavities. Preferably a radiused bend is formed in sheath 13 using a jig and internal mandrel, thereby reducing wear and resistance between drive extender 14 and the interior of sheath 13. Protective sheath 13 should be strong enough that it can be slidingly received in adaptor housing 12 and secured there to using a collet 16, nose piece 17 and nut 18 which threadedly engages male thread 12c. It is to be understood that the nose piece and nut can be integral. Tightening nut 18 onto male thread 12c in position over the nose piece 17 and collet 16 compresses collet 16 about sheath 13 and fixes sheath 13 radially and axially relative to tool 11.

Flexible drive extender 14 is releasably secured at one end in chuck 11 and rotates therewith in a conventional manner. The opposite end of flexible drive extender 14 terminates in a cable adapter such as a threaded spindle 19 proximal the end of sheath 13. A terminal tool 20 such as a cutting point or abrasive point of any suitable shape and material for the project is conventionally attached to the spindle 19 or other cable adapter. The adjustable nature of the collet connection of sheath 13 to housing adapter 12 allows the effective length of the sheath 13 and flexible drive extender 14 to be matched to achieve proper positioning of the terminal tool 20 at the end of sheath 13.

That is to say, with the collet 16 and nut 18 sufficiently loosened, housing adapter 12 can slide along the length of sheath 13 to expose the chuck 11a such that flexible drive extender can be engaged and clamped in the chuck 11a at the length appropriate for the sheath 13. The housing adapter 12 can then be tightened on to connector 11 c and the nut 18 tightened onto the housing connector to maintain the relative position of the sheath 13 and extender 14. Thereafter an operator can use the implement to reach hard to reach surfaces such as an offset surface within a cavity or behind a flange.

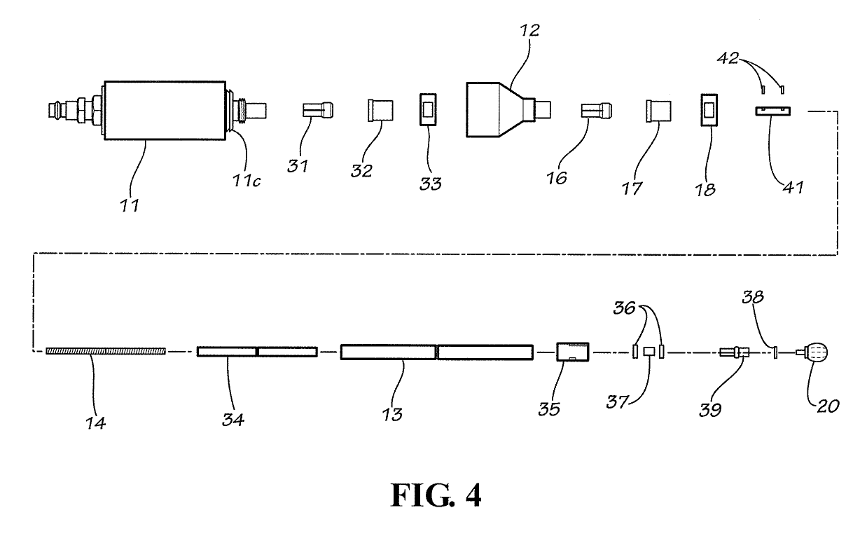

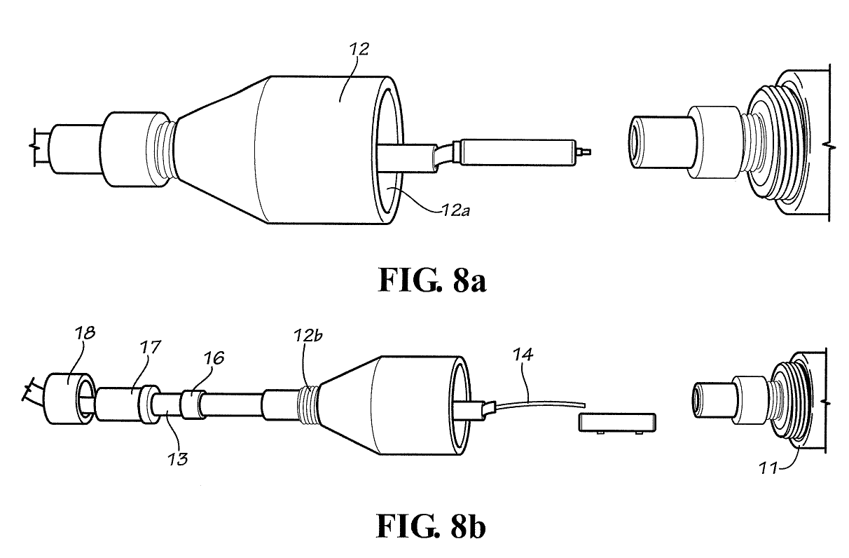

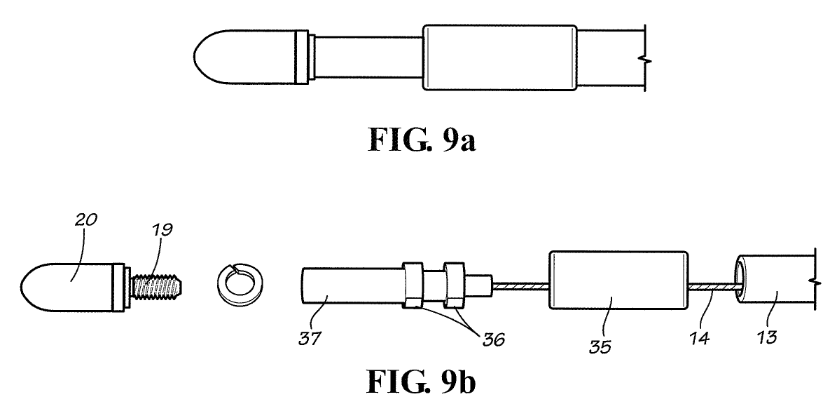

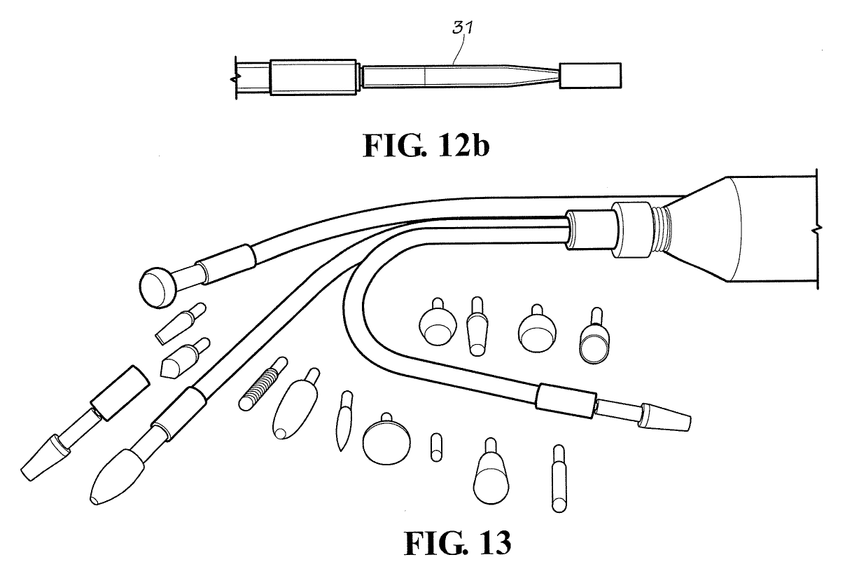

In FIG. 4, I illustrate a second embodiment of the invention which includes details to reduce friction and heating due to the moving parts. Specifically, rotary drive 11 is connected to driver extender 14 using a drive collet 31, drive nose piece 32, and drive nut 33 which combine to grip cable holder 41 which is attached to drive extender 14 using a pair of set screws 42, as also shown in FIGS. 8a and 8b. Housing adapter 12 has an internal thread 12c which engages threaded connection 11C. A nylon liner sheath 34, which may be segmented, is coaxially disposed between drive extender 14 and protective sheath 13. Head mandrel is connected to drive extender at its free end inside head coupler 35, and the terminal end of the drive extender is supported for rotation on a pair of bearings 36 running on a brass spacer bar 37 as may be seen in FIGS. 9a and 9b. The terminal tool 20 is affixed to a head mandrel 39 which may have various configurations as shown in FIGS. 7a and 7b as well as FIGS. 12a 12b and 13. The head mandrel 39 shown in FIG. 7a is knurled for mounting a terminal tool 20 thereto with cement. The head mandrel 39′shown in FIG. 7b is flat to facilitate brazing terminal tool 20 thereon.

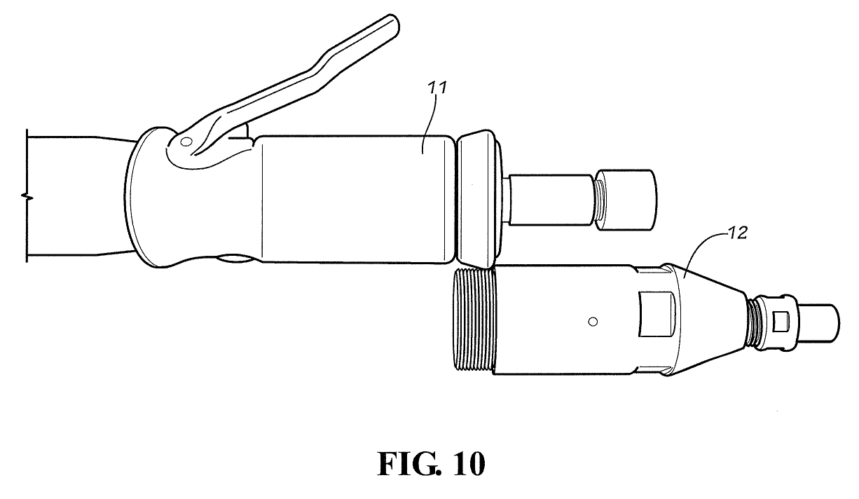

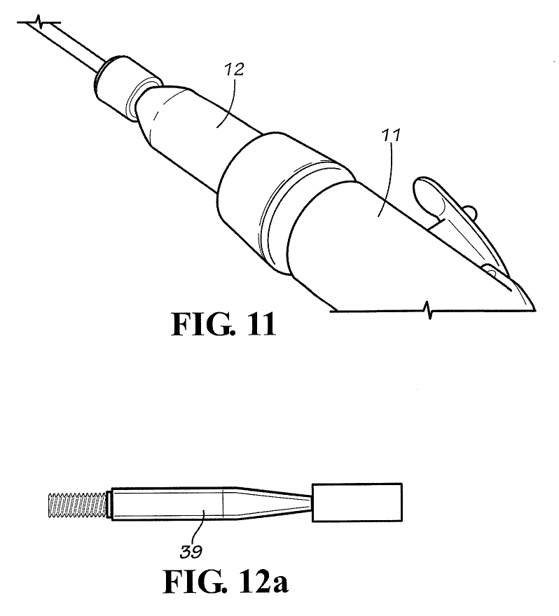

Housing adapter 12 may have internal threads as shown in FIG. 8a or external threads as shown in FIG. 10, depending on how rotary drive 11 is configured. Further, housing adapter 12 may use a compression fit to attach to rotary drive 11 as shown in FIG. 11.

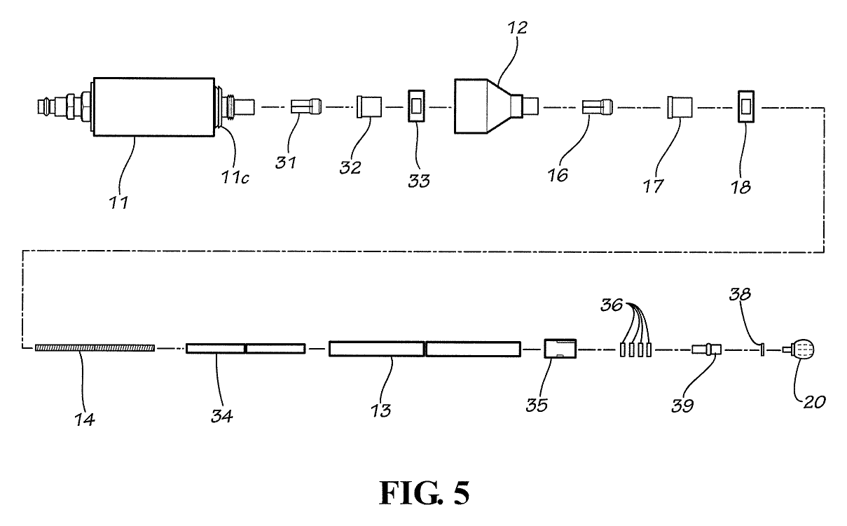

In FIG. 5, yet another embodiment of the invention is shown, with additional bearings 36 supporting the drive extender 14. In this embodiment the drive extender is a heavier cable having a 0.125 outside diameter as opposed to a 0.042 outside diameter cable in the embodiment shown in FIG. 4. Likewise the nylon sheath 34′, spindle 19, locking washer and head coupler are all somewhat more robust for a heavier duty application.

The versatility of the apparatus is shown in FIG. 13 wherein various configurations and terminal tools are illustrated. It is to be understood that the forms of the invention shown are preferred embodiments thereof and that various changes and modifications may be made therein without departing from the spirit of the invention or scope as defined in the following claims.

What is claimed is:

1. An apparatus for use with a rotary drive unit comprising: an adapter housing releasably secured to said rotary drive unit; a protective sheath slidably received in said adapter housing and selectively secured thereto at an operable position; a flexible drive extender connected to said rotary drive unit within said adapter housing for rotation with said drive unit and extending through said protective sheath for attachment to a terminal tool.

2. An apparatus as defined in claim 1 wherein said adaptor housing comprises a truncated tubular member having a first end releasably secured to said rotary drive unit coaxially about said flexible drive extender.

3. An apparatus as defined in claim 2 wherein said protective sheath is adjustably connected to said adapter housing by a collet connection.

4. An apparatus as defined in claim 1, wherein said protective sheath is commensurate with the length of said flexible drive connector.

5. An apparatus as defined in claim 4 wherein said protective sheath can be deformed to a fixed radiused turn along its length such that said terminal tool may be disposed to engage a surface within an offset cavity.

6. An apparatus as defined in claim 2 wherein said protective sheath is an elongate metallic tube commensurate with the length of said flexible drive connector.

7. An apparatus as defined in claim 6 wherein a nylon sheath is disposed within said metallic tube.

8. An apparatus as defined in claim l wherein said protective sheath can be deformed to a fixed radiused turn along its length such that said terminal tool may be disposed to engage a surface within an offset cavity.

9. An apparatus for use with a rotary drive unit comprising: an adapter housing in the form of a truncated tubular member having a first end releasably secured to said rotary drive unit coaxially about a flexible drive extender; a metallic protective sheath slidably received in said adapter housing and selectively secured thereto at an operable position such that the length of said sheath is commensurate with the length of said flexible drive extender; said flexible drive extender connected to said rotary drive unit within said adapter housing for rotation by said drive unit and extending through said protective sheath for attachment to a terminal tool, wherein said protective sheath can be deformed to a fixed radiused turn along its length such that said terminal tool may be disposed to engage a surface within an offset cavity.

10. An apparatus for use with a rotary drive unit comprising: an elongated metallic protective sheath capable of being formed to provide access to said drive unit around obstructions, said elongated metallic protective sheath being releasably and non-rotatably coupled to said drive unit in a selected orientation; a elongated flexible drive extender releasably coupled to said drive unit for rotation and extending through said protective sheath to a free end thereof and affixed to a terminal tool such that said tool is driven by said drive extender.
